(19) United States
(12) Patent Application Publication
(10) Pub. No.: US 2017/0144866 A1
(43) Pub. Date: May 25, 2017

(54) ANCHOR POINT COMPRISING A TEXTILE LOOP

(71) Applicant: RUD KETTEN RIEGER & DIETZ GMBH U.CO.KG, Aalen (DE)

(72) Inventor: Reinhard Smetz, Nordlingen-Kleinerdlingen (DE)

(21) Appl. No.: 15/309,616

(22) PCT Filed: Apr. 29, 2015
(86) PCT No.: PCT/EP2015/059391

§ 371 Date: Dec. 15, 2016

(30) Foreign Application Priority Data
May 9, 2014 (DE) 10 2014 208 822.4

(51) Int. Cl. B66C 1/66; B60P 7/08

(52) U.S. Cl. CPC B66C 1/66; B60P 7/0807

(57) ABSTRACT

The invention relates to an attachment point (1) for lifting, lashing and/or fastening of loads, with a fastening section (11) for installing a load, and with an eye (5). In addition, the invention relates to a method for lifting, lashing and/or fastening of loads. To provide an attachment point (1) that has a low weight, which enables a low-noise operation and which has the highest possible flexibility for fastening a sling, it is provided according to the invention that a textile sling (3) is installed in the eye (5).

The invention relates to an attachment point for lifting, lashing and/or attaching of loads, with a fixing section for installing a load and with an eye. In addition, the invention relates to a method for lifting, lashing and/or fastening of loads.

Attachment points are widely used, in particular in lifting and transport technology. Attachment points are usually connected firmly with a load. For this purpose, a fastening section of the attachment point is used. For fastening, attachment points can inter alia be screwed or welded on a load. An attachment point usually has an eye. The eye can be used for receiving a connection element. The connection element, in turn, is used for connecting the attachment point to an attachment sling. Known connection elements are for example shackles or welded chain links. However, the high manufacturing costs, the high weight as well as the rigid structure, in particular for a welded chain link as a connection element, are disadvantageous in known attachment points and the pertaining connection elements. A further disadvantage of the known attachment points is that sensitive surfaces or edges of the loads to be lifted can be damaged by the connection elements. This is critical in particular when the loads are unprotected components. Damages by the connection elements can for example be caused in cases where connection elements made of steel fall onto the product to be lifted, which can happen if they are detached from the sling or if the traction of the sling declines.

Therefore, the purpose of the invention is to provide an attachment point and a method with the features mentioned initially that has a higher flexibility while having a lower weight compared to the known attachment points and that can in addition be manufactured cost-efficiently.

This problem is solved according to the invention by a textile sling being installed in the eye. For the method, the problem is solved by a sling that will be connected undetachably to an eye of an attachment point via an endless textile sling.

A textile sling, which is installed in the eye as a connection element, has a considerably lower weight than a connection element made of steel with the same length. In addition, a textile sling has an increased deformability compared to a fixed connection element so that handling can be simplified for the connection of slings with the attachment point. The textile sling prevents damages on the load to be lifted, even if the textile sling falls onto the load, because the textile sling is usually soft enough in order to not be a risk for the load to be lifted. Compared to connection elements made of steel, a noise-reduced operation is possible with the textile sling. In addition the textile sling can be less susceptible with regard to corrosive environments such as salt water. Common textiles, for example made of synthetic materials, are usually more resistant with regard to acids than the known connection elements made of steel. Therefore, a particularly safe and long-lived operation is possible with the textile sling. It is also possible to guide the textile sling around a protected edge, for example the cutting edge of a work piece so that the edge is arranged between the attachment point and the sling. An arrangement with a known connection element, in which such connection element fits closely to an edge of the work piece, could, in turn, lead to the edge being damaged.

The textile sling is made preferably of strip material. However, it can equally be made of a suitable round rope.

The solution according to the invention can be further improved by means of different variants that are each advantageous in itself and that can be combined with one another in any way. In the following, these embodiments and the advantages that come with them will be addressed in the following.

According to a first advantageous variant, the eye can be closed all round. Then, the textile sling is held undetachably in the eye. In addition, an eye that is closed all round can enable the production of a particularly compact and stable attachment point. Alternatively, the eye can be open towards a lower side of the attachment point.

In particular if the eye is closed all round, the textile sling can be sewed into the eye. This way, a continuous, endless textile sling can be obtained. The sewed-in textile sling also offers the advantage of the sling not having any disturbing connection points such as knots or squeezing zones so that it can be guided through the eye in an unhampered and endless way. This enables a particularly easy handling of the attachment point as each point of the textile sling can be used in an equal way for connection with the sling. It is particularly advantageous to have a sewed-in textile sling that is arranged in an eye that is closed all round. Therefore, a separation of the textile sling from the attachment point can be excluded with the exception of damages or overloads.

For sewing, for example a strip or a rope piece, whose ends will then be sewed to one another, of the textile material can be threaded through the eye so that an endless sling is formed.

A width of the textile sling can be at least half as large and at most as large as a diameter of the eye. Therefore, a good flexibility of the textile sling in the eye is enabled. To achieve a particularly good force transmission between the textile sling and the eye, the width of the textile sling can preferably be 80% to 100% of the eye diameter.

To ensure flexibility of the textile sling in the eye and to reduce at the same time the risk of damages and premature wear of the textile sling, the eye can be burr-free. For this purpose, the eye can for example be ground smooth and/or polished prior to inserting the textile sling.

The eye can form an attachment arc, which is burr-free, on the side that faces away from the fastening section. Thereby, the textile sling can align itself slightly in different end stop directions under load. The textile sling will then be flexible without disturbance in the eye.

To achieve a particularly stable textile sling, the textile sling can be sewed and/or woven of a synthetic chemical fiber. Thereby, in particular high-performance polyethylene materials (HPPE), in particular ultra-high molecular polyethylene (UHMW-PE) can be used as chemical fibers.

The size of the textile sling can in particular be chosen in a way that it corresponds to the sizes of the known connection elements. In particular, the size and the bearing capacity of the textile sling can be adapted in accordance with international norms in order to replace the already known attachment points and connection elements. In this context, in particular the norms DIN 5688-3, which determines dimensions for connection elements, as well as the norms DIN EN 1677-2, -3 and -4, DIN EN 13889, DIN 82101, DIN 82016 as well as the British norm British Standard 3032 and the U.S. Norm Fed. Spec. RR-C-271, shall be mentioned.

In the following, the invention is explained in greater detail in an exemplary way based on different embodiments with reference to the drawings. The combinations of features displayed exemplarily in the embodiments can, pursuant to the above explanations, be complemented in accordance with the properties of the attachment point according to the invention, which are required for a specific application case, by further features. Likewise and also pursuant to the above explanations, individual features can be omitted in the described embodiments if the effect of such feature is not relevant in a specific application case. For elements with an identical function and/or identical structure, the same reference signs will always be used in the drawings.

The Figures show:

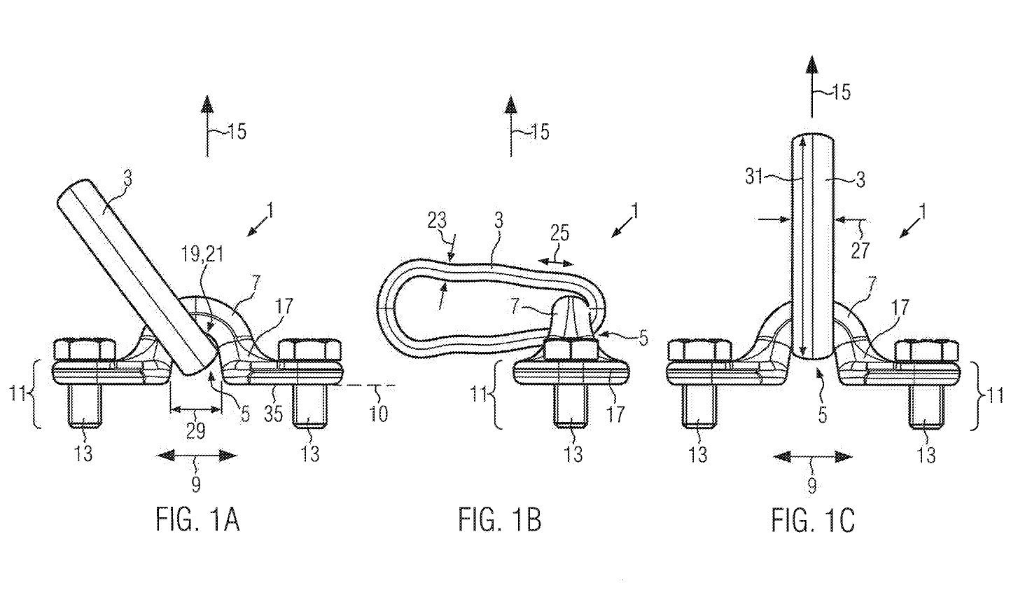

FIG. 1A-1C an attachment point with two fastening elements and an eye that is open towards the fastening section;

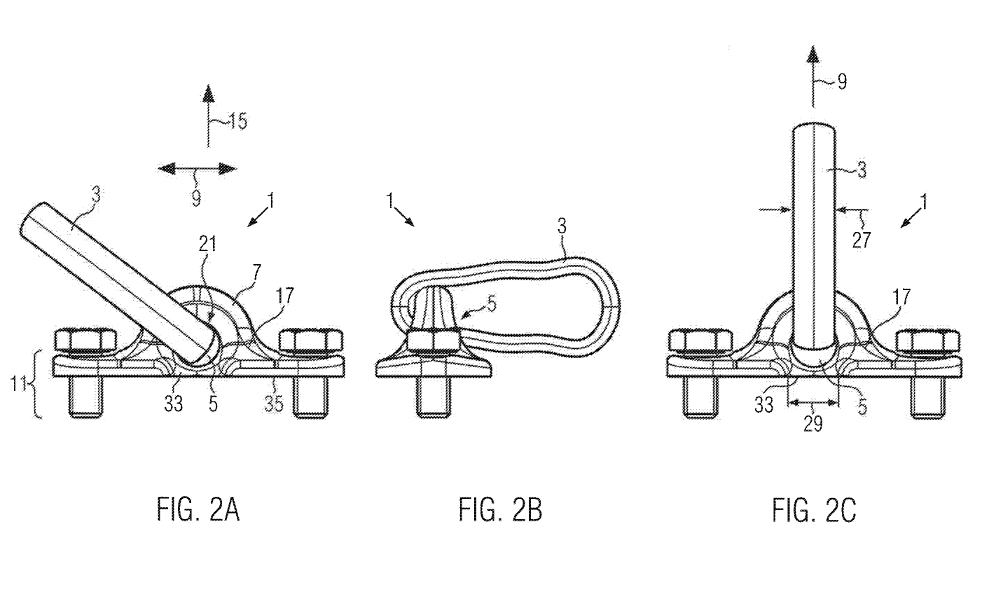

FIG. 2A-2C an attachment point similar to the one in FIG. 1A-1C but with an eye that is closed all round;

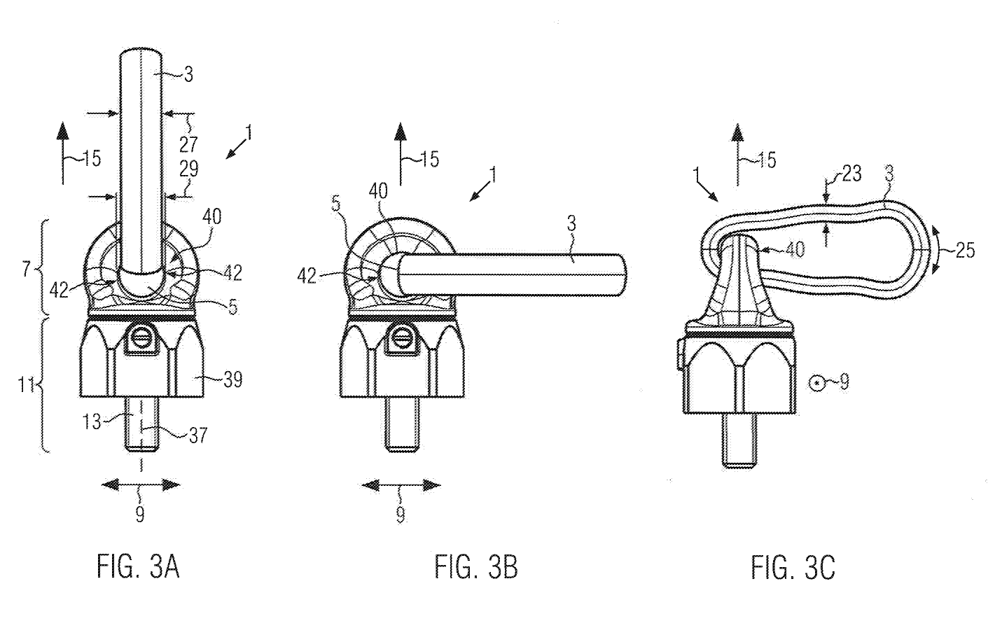

FIG. 3A-3C an attachment point supported by a ball bearing with a centrally arranged eye;

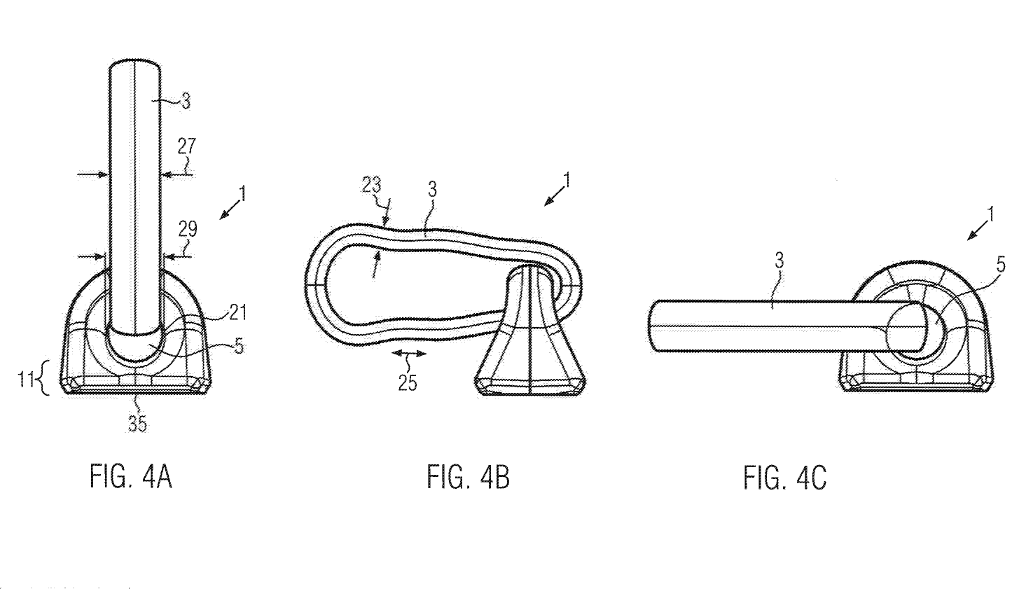

FIG. 4A-4C a weldable attachment point with a centrally arranged eye;

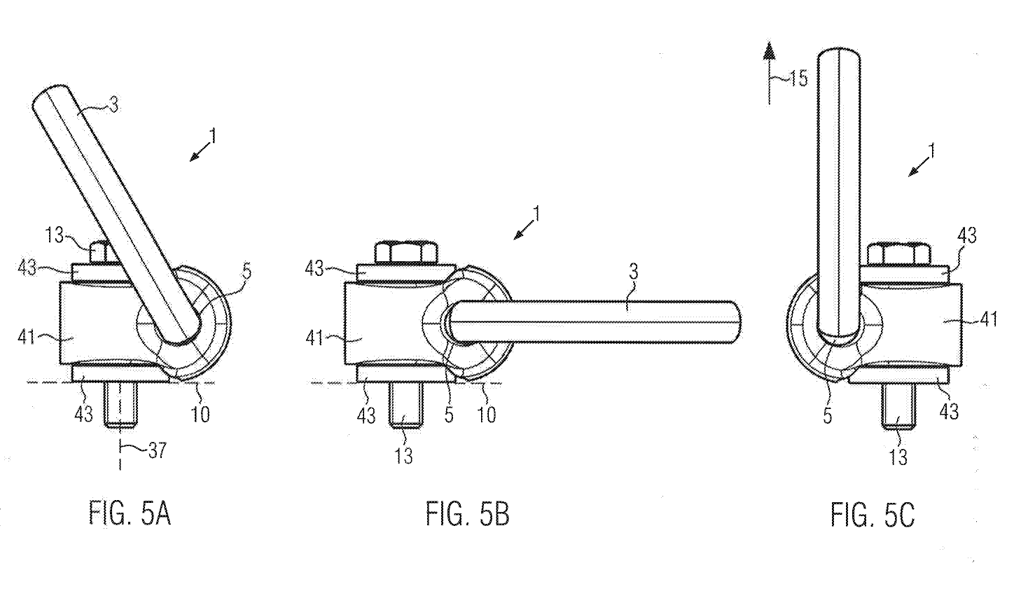

FIG. 5A-5C a rotatable attachment point with an eccentrically arranged eye;

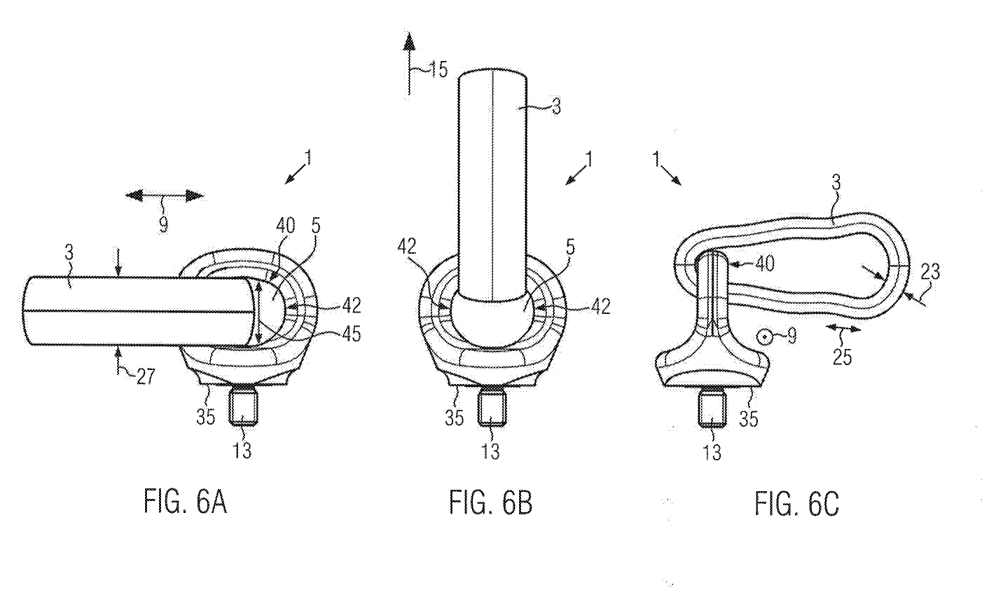

FIG. 6A-6C an attachment point with a fastening element and an eye that is closed all round; respectively with the textile sling in three different directions of load,

The attachment point according to the invention with a textile sling is described in great detail with reference to the FIG. 1A to 1C. For the sake of conciseness, further embodiments will only be described with regard to how they differ from the first embodiments and with reference to the FIG. 2A to 6C.

FIG. 1A to 1C show a first embodiment of the attachment point 1 according to the invention with a textile sling 3. The eye 5 of the attachment point 1 is formed by a ring section 7 of the attachment point 1. The attachment point 1 has a straight underside 35 that extends in parallel to a load plane 10. The ring section 7 and the load plane 10 predetermine a longitudinal direction 9 of the attachment point 1.

The attachment point 1 has a fastening section 11 to install a load (not shown). Fastening elements 13 can be arranged in the fastening section 11. The embodiment illustrated in the FIG. 1A to 1C has two fastening elements 13 that are arranged along the longitudinal direction 9 and at a distance from the eye 5. The fastening elements 13 are formed preferably by screws. By means of such screws, the attachment point 1 can be fastened on a load safely and in a repeatedly detachable way.

The main direction of load 15 extends facing away from the fastening section 11 and perpendicularly to the longitudinal direction 9. FIG. 1A to 1C show the embodiment of an attachment point 1 according to the invention wherein the textile sling 3 is displayed respectively pointing in different directions of load. FIG. 1A shows the textile sling 3 in a direction that is diagonal between the longitudinal direction 9 and the main direction of load 15. FIG. 1B shows a lateral view of the attachment point 1 with the textile sling 3 in a direction that is perpendicular to the longitudinal direction 9 and perpendicular to the main direction of load 15. FIG. 1C shows the textile sling pointing in the main direction of load 15.

The eye 5 is opened towards the fastening section 11. This embodiment allows for the separate production of a body 17 of the attachment point 1 and the textile sling 3. Then, the textile sling 3 can for example be hung up into the eye 5 directly prior to fastening the attachment point 1 on a load. A simplified production, in particular of the textile sling 3, can thereby be achieved. In addition, there is the possibility to simply replace the textile sling 3 by removing the attachment point 1 from a load by means of detaching the fastening elements 13 and by attaching it once again after replacement of the textile sling 3.

The eye 5 is preferably burr-free. This can be achieved through appropriate manufacturing methods during production of the body 17, in particular of the ring section 7. The burr-free eye 5 enables both the disturbance-free as well as a damage-free movement of the textile sling 3 within the eye 5.

On the side 19 of the eye 5 that faces away from the fastening section 11, the eye forms an attachment arc 21. The attachment arc 21 enables the alignment of the textile sling 3 within the eye 5, in particular along the longitudinal direction 9. The attachment arc 21 is preferably designed in an edge-free way so that a change of the direction of load is possible without being complicated due to the textile sling 3 hanging firmly within the eye 5.

The textile sling 3 is preferably manufactured endlessly. Preferably, it has no knots or connection elements formed by squeezing or clamping. The textile sling 3 preferably has a continuous cross-section 23. Slight deviations from the cross-section 23, for example by seams or by partially overlapping textile sections on the seam joints can be tolerated. The even cross-section 23 enables a free flexibility of the textile sling 3 along a sling direction 25. This can for example avoid that the textile sling 3 will have to be moved at first along the sling direction 25 in order to move for example a knot point to a position at which such knot point will disturb when the load hits the end stop.

The width 27 of the textile sling 3 corresponds preferably at least to half of the eye diameter 29 and is preferably not wider than such this eye diameter 29. Particularly preferably, the width 27 of the textile sling 3 is equivalent to 80% to 100% of the eye diameter 29. The essentially complete use of the eye diameter 29 by the width 27 of the textile sling 3 allows for an even force transmission from the textile sling 3 to the attachment arc 21 of the eye 5. The length 31 of the textile sling 3 is preferably chosen in a way that the textile sling 3 can replace known connection elements, for example made of steel. The dimensions of such connections are indicated in the norms mentioned above.

FIG. 2A to 2C show a further embodiment of the attachment point 1 according to the invention 1. In the following, the differences with regard to the embodiment described with reference to FIG. 1A to 1C will be explained.

The embodiment of the attachment point 1 shown in FIG. 2A to 2C has an eye 5 that is closed all round. On the side that is opposite to the attachment arc 21, the body 17 of the attachment point 1 has a crosspiece 33 that extends essentially along the longitudinal direction 9 and that closes the eye 5. The eye 5 is preferably formed as a circle, burr- and edge-free. The width 27 of the textile sling 3 essentially corresponds to the diameter 29 of the eye 5. A continuous, straight underside 35 is formed by the crosspiece 33 on the side of the fastening section 11 that faces away from the ring section 7.

The textile sling 3 is preferably sewed into the eye 5. Then the textile sling 3 can no longer be detached from the eye 5 except if it is destroyed. This has the advantage that only suitable and/or approved textile slings 3 will be used in the attachment point 1. The use of an inappropriate textile sling 3 in the eye 5 is thereby excluded. Another advantage is the undetachability. If the attachment point 1 according to the invention is used or transported, the textile sling 3 cannot fall out of the eye 5.

FIG. 3A to 3C show a further embodiment of an attachment point 1 according to the invention with a textile sling 3. FIG. 3A and 3B thereby show a lateral view of the attachment point 1 from a direction that is transversal to the longitudinal direction 9 and FIG. 3C shows a lateral view of the attachment point 1 along the longitudinal direction 9. The three Figures show the textile sling 3 pointing respectively in different directions of load.

The attachment point 1 of the displayed embodiment is an attachment point 1 with a ball bearing. The ring section 7 is installed rotatably around a rotary axis 37 opposite to the fastening section 11. The fastening section 11 has a base 39 in whose inside (not shown) roller bearings are installed. A part of the ring section 7 protrudes into the basis 39 and is installed rotatably in the base 39 by means of roller bearings. The eye 5 is arranged centrically to the rotary axis 37. The ring section 7 with the eye 5 rotates in the main direction of load 15, viewed from above the fastening section 11.

The fastening section 11 has a fastening element 13 that points in the opposite of the main direction of load 15 and that is arranged centrically to the rotary axis 37. The fastening element 13 is preferably a screw. The base 39 can have a hexagonal form so that it can be rotated with a suitable tool. Therefore, the attachment point 1 can be fastened on a load (not shown). A rotation of the base 39 consequently leads to the fastening element 11 with the fastening element 13 being screwed into an accordingly designed thread. Alternatively, the fastening element 13 can also be pushed through an opening in the load and secured on the load with a counter-fastening element such as a nut.

The centrical fastening of the attachment point 1 allows a greater movement leeway for the textile sling 3 compared to the embodiments described with reference to FIG. 1A to 2C. As displayed in FIG. 3B, also an alignment of the textile sling 3 perpendicularly to the main direction of load 15 and along the longitudinal direction 9 and/or in parallel to the load plane 10 is now possible because the textile sling 3 is not hampered by additional fastening elements 13 arranged laterally from the eye 5. In case of such an alignment, the textile sling 3 fits closely to the lateral section 42 on the inside of the eye 5. An alignment of the textile sling 3 in the main direction of load 15 (FIG. 3A) as well as perpendicularly to the main direction of load 15 and at the same time perpendicularly to the longitudinal direction 9 (FIG. 3C) as well as all intermediate steps are possibly without disturbance. In these two alignments, the textile sling 3 fits closely to the upper section 40 on the inside of the eye 5. The eye 5 is preferably formed circularly and burr- and edge-free. Also in this embodiment, the width 27 of the textile sling 3 is preferably equivalent to between 80 and 100% of the eye diameter 29. The textile sling 3 is preferably sewed into the eye 5 and has a continuous cross-section 23 along the sling direction 25.

FIG. 4A to 40 show a fourth embodiment of the attachment point 1 according to the invention. The fourth embodiment of the attachment point 1 according to the invention is a weldable attachment point 1 whose fastening section 11 is formed essentially by a straight underside 35. On the straight underside 35, the attachment point 1 can be welded to a load.

The attachment point 1 has an eye 5 that is closed all round. The eye 5 is preferably formed in a circular way. As in the embodiment described with reference to the FIG. 3A to 30, this embodiment does not have any fastening elements 13 that are spaced from the eye 5 in the longitudinal direction 9, so that the textile sling 3 can take the positions that have already been described with reference to the FIG. 3A to 3C. Also in this embodiment, the textile sling 3 has an essentially even cross-section 23 along the sling direction 25. Also here, the width 27 of the textile sling 3 is preferably 80 to 100% of the eye diameter 29 so that a good and even force transmission from the textile sling 3 to the attachment arc 21 of the attachment point 1 is possible.

FIG. 5A to 5C show a fifth embodiment of an attachment point 1 according to the invention with a textile sling 3.

The attachment point 1 is installed rotatably around the rotary axis 37. Therefore, it has a connection element 41 that is rotatable around a bushing 43. The bushing 43, which can consist of multiple parts, can be fastened on the load by the fastening element 13 that protrudes through the bushing 43. The connection element 41 bears the eye 5. The textile sling 3 is installed in the eye 5. The eye 5 is arranged eccentrically to the rotary axis 37. Through a rotation of the connection element 41, the textile sling 3 installed in the eye 5 is rotatable around the rotary axis 37 in parallel to the load plane 10.

The textile sling 3 can be aligned in parallel to the load plane 10 (FIG. 5C) and can be arranged, due to the rotatability of the attachment point 1, in any direction that is perpendicular to the rotary axis 37. Through the flexibility of the textile sling 3 in the eye 5, the textile sling 3 can also be arranged in a way that it points into the main direction of load 15 (FIG. 5B). Likewise, all intermediate steps between the positions shown in FIG. 5B and 5C are possible. A position in which the textile sling 3 protrudes beyond the fastening element 13 (FIG. 5A) is also possible. However, the fastening element 41 is preferably rotated at first in the direction in which the textile sling 3 is fastened on a sling in order to prevent an uncontrolled rotation under load.

FIG. 6A to 6C show a sixth embodiment of an end stop 1 according to the invention with a textile sling 3. The fastening element 13 is formed as one part with the attachment point 1. The fastening element 13 is a threaded rod that extends away from the underside 35. The attachment point 1 can be fastened on a load like a screw on an appropriate thread. The eye 5 of the attachment point 1 is closed all round and designed preferably in a burr-free way. The eye 5 has a slightly oval form and is slightly flattened in the main direction of load 15. Alternatively, the eye 5 can also be designed circularly.

Just as in the embodiments described before, the textile sling 3 is preferably manufactured endlessly and continuously and has an essentially constant cross section 23 along the sling direction 25. The width 27 of the textile sling 3 corresponds approximately to the height 45 of the eye 5. The textile sling 3 can be aligned in parallel to the longitudinal direction 9 and perpendicularly to the main direction of load 15 in the eye 5 (FIG. 6A). Likewise, the textile sling 3 can extend along the main fastening direction 15 (FIG. 6B) or transversally to the longitudinal direction 9 and transversally to the main direction of load 15 (FIG. 6C). As in the embodiments described with reference to the FIGS. 3 and 4, the textile sling 3 fits closely to an upper section 40 of the eye 5 in case of an alignment along the main direction of load 15 and in case of an alignment that is transversal to the main direction of load 15 and at the same time transversal to the longitudinal direction 9 (FIG. 6C). In case of alignment in the longitudinal direction 9, the textile sling 3 essentially fits closely to a lateral section 42 of the eye 5.

### REFERENCE NUMERALS

1 Attachment point
3 Textile sling
5 Eye
7 Ring section
9 Longitudinal direction
10 Load plane
11 Fastening section
13 Fastening element
15 Main direction of load
17 Body
19 Side of the fastening section that faces away from the eye
21 Attachment arc
23 Cross-section
25 Sling direction
27 Width
29 Eye diameter
31 Length
33 Crosspiece
35 Underside
37 Rotary axis
39 Base
40 Upper section
41 Connection element
42 Lateral section
43 Bushing
45 Height

1. Attachment point (1) for lifting, lashing and/or attaching of loads, with a fastening section (11) to install a load, and with an eye (5), characterized in that a textile sling (3) is installed in the eye (5).

2. Attachment point (1) according to claim 1, characterized in that the eye (5) is closed all round.

3. Attachment point (1) according to claim 1 or 2, characterized in that the textile sling (3) is sewed into the eye (5).

4. Attachment point (1) according to one of the claims 1 to 3, characterized in that the eye (5) is burr-free.

5. Attachment point (1) according to one of the claims 1 to 4, characterized in that the eye (5) forms an attachment arc (21) that is edge-free on the side (19) that faces away from the fastening section (11).

6. Attachment point (1) according to one of the claims 1 to 5, characterized in that the textile sling (3) is sewed or woven of a synthetic chemical fiber.

7. Method for lifting, lashing and/or fastening of loads, characterized in that a sling is connected with an eye (5) of the Attachment point through an endless textile sling (3).

8. Method according to claim 7, characterized in that the textile sling (3) is sewed up in the eye (5).

9. Use of the attachment point (1) with a textile sling (3).
